(19) United States
(12) Patent Application Publication
(10) Pub. No.: US 2010/0057708 A1
(43) Pub. Date: Mar. 4, 2010

(54) Method and System for Computer-Based Assessment Including a Search and Select Process

(76) Inventor: William Henry Billingsley, Histon (GB)

Correspondence Address: William Billingsley, 334 Fig Tree Pocket Road, Fig Tree Pocket, Queensland, 4069, AU

(21) Appl. No.: 12/203,909

(22) Filed: Sep. 3, 2008

(51) Int. Cl. G06F 17/30

(52) U.S. Cl. 707/4; 707/E17.001

(57) ABSTRACT

A system and method for computer based assessment in which at least one question prompt is displayed and means for a user to enter at least one search query is provided. Potential answers that are deemed relevant to entered search queries are displayed to the user and may be selected to form all or part of the user's answer. Because users select pre-determined potential answers, rather than construct answers, appropriate feedback and a mark score can be determined simply and unambiguously. Because potential answers are only displayed in response to a relevant search query being entered, users cannot simply recognize a potential answer as being correct without first having actively searched for it, and the set of potential answers for a question can be relatively large as only the subset that are relevant to a search query are displayed for selection at any one time.

### CROSS-REFERENCE TO RELATED APPLICATION

Not applicable

### STATEMENT REGARDING FEDERALLY SPONSORED RESEARCH OR DEVELOPMENT

Not applicable

### REFERENCE TO A SEQUENCE LISTING OR TO A COMPUTER PROGRAM LISTING COMPACT DISC APPENDIX

Not applicable

### BACKGROUND OF THE INVENTION

This application relates to a method and system for computer-based assessment. More specifically, this application relates to a method and system for computer-based assessment in which users select answers from a set of pre-written potential answers but those pre-written potential answers are revealed to users only in response to relevant search queries being entered.

In computer based assessment (sometimes called computer-aided assessment or e-Assessment), a challenge is how to ask a question without giving the correct answer away to the human users, while ensuring that the submitted answers can be interpreted unambiguously and marked accurately.

If a question gives away the correct answer, or makes it likely that a user can guess a correct answer, then it falls short in its goal of assessing the human user's knowledge or understanding. In summative assessment, where a human user is being assessed for course credit, users might receive undeserved credit. In formative assessment, where the assessment is intended to help a human user to learn, opportunities to diagnose the user's misconceptions might be missed.

If a submitted answer is not accurately interpreted, then in summative assessment it might be mismarked, and in formative assessment, suitable feedback might not be identified.

Questions where the human user must write or construct an answer, rather than selecting an answer from a provided list of potential answers, are known in the art as “constructed response questions”. Constructed response questions where the expected answer is short are known as short answer questions.

In constructed response questions, interpreting submitted answers automatically and accurately can be problematic.

A common approach in specialized subjects is to pass the submitted answers to a processing engine for analysis. For example, Alice Interactive Mathematics passes submitted answers to the Maple mathematical analysis system. This attempts to ensure that equivalent but lexically different answers (for example a+b instead of b+a) are marked the same. However, this approach has a number of shortcomings. The specialized systems are only useable for the very specialized questions they were designed for, making wide-ranging tests difficult to implement. For example, Alice Interactive Mathematics only supports questions where the answer is a short piece of mathematics, and cannot support questions where the answer is an English language sentence. The analysis systems are intolerant of syntactical errors that a human marker might consider unimportant (for example, typographical errors). Writing questions requires specialized knowledge of the analysis system. In some systems, such as Alice Interactive Mathematics, care must be taken to ensure that students cannot “game the system” by getting the analysis system to answer the question for them. For example, in the question “Calculate sin(3)”, the answer “sin(3)” must be disallowed, as must “cos(3−π/2)”.

Another well-known approach is to ask a question that expects an answer in natural language (for example, English), and use natural language processing (NLP) to assess submitted answers. In this approach, the quality of marking depends on the accuracy of the NLP system that is used. While NLP is improving, it remains imperfect. The accuracy rate for using NLP to diagnose meaning errors in short answer questions can be around 85%. That leaves around 15% of answers being mismarked. NLP is widely regarded as complex, and can be difficult for a teacher to extend for new terminology. Furthermore, as human users are aware that automatically interpreting natural language is difficult, they can lack confidence that their answers will be accurately assessed.

An alternative to using constructed response questions is to use questions where the human user selects an answer from a set of pre-written potential answers. Because the human user can only submit answers that were pre-written, there is no ambiguity in how the answer should be interpreted. However, the systems and methods used in the art so far have other shortcomings.

“Multiple Choice Questions” are a well-known art and are used in many computer-based tests. Each user is presented with the question prompt and a set of potential answers. The user then selects one or more of the potential answers as his or her answer. The selected answer is then assessed. Feedback can be given to the user and a mark recorded.

Because a set of potential answers is displayed to the user before he or she enters any information about his or her intended answer, it can be possible for the user to recognize a correct answer in the set, even if he or she would not have recalled or deduced that answer if it had not been displayed. Users may also be able to select an answer by a process of elimination, determining that the alternative potential answers are incorrect rather than determining that the chosen answer is correct.

If many potential answers are presented, then reading the set of potential answers is a significant effort, and it can be difficult for users who have deduced or recalled an intended answer to identify which potential answer in the displayed set is most similar to the answer they intend.

If few potential answers are presented, then a user choosing a potential answer at random has a significant probability of selecting a correct answer.

If few potential answers are presented, then there is an increased likelihood that users who deduce or recall an intended answer will be unable to find any potential answer in the displayed set that is similar to the answer they intend. In formative assessment, where questions are asked primarily in order to provide feedback to users, this can limit the assessment's ability to give appropriate feedback to those users.

The popular perception of these problems with Multiple Choice Questions reduces users' confidence that a computer-based assessment using Multiple Choice Questions is thorough and valid.

Extended Multiple Choice Questions (EMCQS) are widely used in assessment for medical students. These have a longer list of potential answers, often around 40. To overcome the problem that it is a significant effort for the human user to read all of the potential answers, the same list of potential answers is used for a number of questions. This does, however, limit the assessment, as the questions must be constructed so that the same potential answers are credible alternatives for the entire sequence of questions. For example, the questions “what is the highest mountain in Europe” and “in what year was Winston Churchill born” could not feasibly be asked in the same EMCQ sequence, as mountain names are easily distinguishable from years even by unknowledgeable users. Furthermore, human users can still recognize answers in the list that they would not have recalled.

### BRIEF SUMMARY OF THE INVENTION

The present invention includes a system and method for computer based assessment in which at least one question prompt is displayed and means for a user to enter at least one search query is provided. Entered search queries are used to identify relevant potential answers to display. Potential answers that are deemed relevant to a search query are displayed to the user and at least one potential answer may be selected by the user as an answer. Because users do not construct answers but select answers from displayed potential answers, feedback and a mark score can be determined simply and unambiguously. Users cannot simply recognize potential answers without actively recalling or deducing them, because they must enter a search query that is deemed relevant to a potential answer before it is displayed. Because only a subset of the potential answers for a question are displayed at any one time (those that are deemed relevant to entered search queries), the set of potential answers for a question can be relatively large without imposing a significant reading burden on each user. This in turn means that it is much less likely that answers selected at random are correct, thus guessing is a less viable strategy. Furthermore, before a user could guess an answer, he or she would already have had to enter a relevant search query to that potential answer.

### BRIEF DESCRIPTION OF THE SEVERAL VIEWS OF THE DRAWING

FIG. 1A is a block diagram illustrating an exemplary data computing environment in which the invention may be implemented.

FIG. 1B is a block diagram illustrating how exemplary software components of one embodiment of the present invention relate to the exemplary data computing environment.

FIG. 2 is a block diagram illustrating exemplary server software components of one embodiment of the present invention.

FIG. 3A is a logic flow diagram illustrating an exemplary technique for responding to a human user's input in a question.

FIG. 3B is a logic flow diagram illustrating an exemplary technique for outputting a search and answer form for a question.

FIG. 3C is a logic flow diagram illustrating an exemplary technique for searching an index store to retrieve a list of potential answers.

FIG. 4 is a logic flow diagram illustrating a technique for an index servlet to write details about a question record to an index store.

FIG. 5 is a logic flow diagram illustrating a technique for a question analyzer to construct a token stream from a reader that reads answer data for the question.

FIG. 6 is a logic flow diagram illustrating a technique for a synonym filter to determine the next token that it should return.

FIG. 7 is an illustration of a screen display of a question after a human user first accesses the question.

FIG. 8 is an illustration of portions of output that may be displayed during a question.

FIG. 9 is an illustration of a screen display of a question after a human user has completed selecting answers.

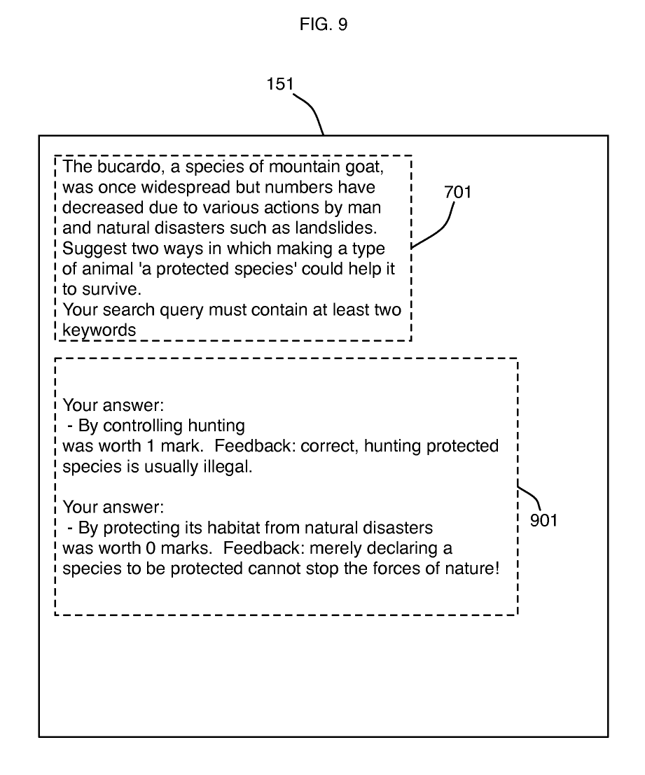

### DETAILED DESCRIPTION OF THE INVENTION

### First Embodiment

Exemplary Hardware Operating Environment

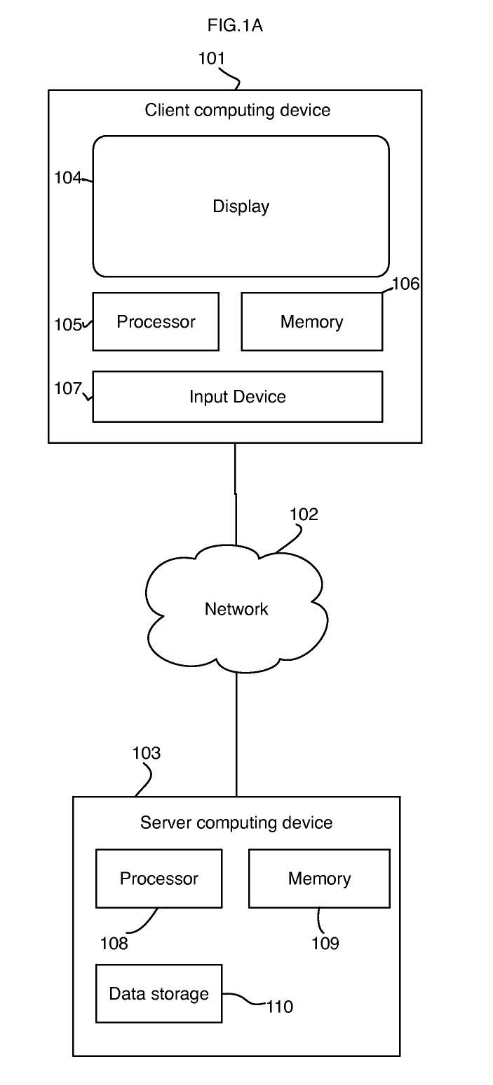

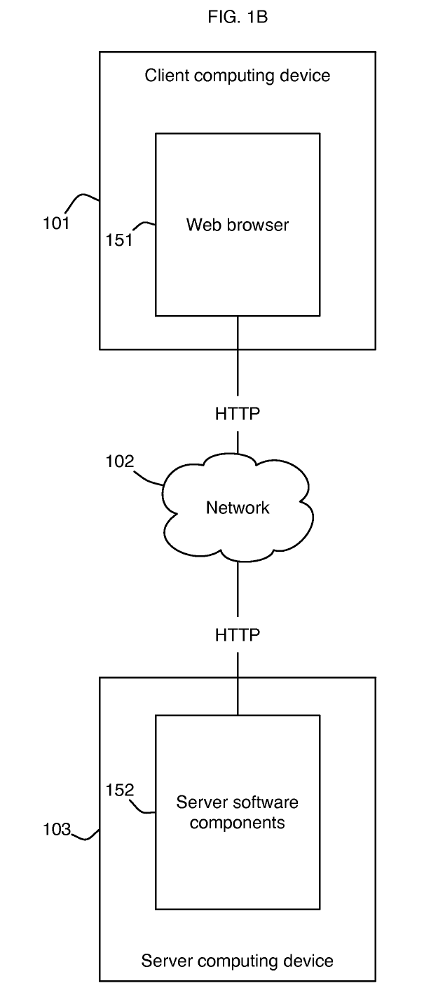

FIG. 1A shows a block diagram of a data computing environment in which the invention may be implemented. A client computing device 101 is connected via a network 102 to a server computing device 103.

The client computing device 101 includes a display 104 on which output can be shown, a processor 105, memory 106, and at least one input device 107 that the human user can use to input data. Client computing devices including these components are well known in the art, and means for interconnecting these components are well known in the art. An example client computing device would be a notebook computer, for example an Apple MacBook. Other example client computing devices include personal computers, hand-held computing devices such as an Apple iPod Touch or other hand-held computing device, Ultra-Mobile Personal Computers, smart-phones, and thin client computer terminals.

An example of a suitable network 102 would be an office local area network. Other examples include enterprise-wide computer networks, wide area networks, wireless networks, the global Internet, and other means of connecting a plurality of computing devices.

The server computing device 103 includes a processor 108, memory 109, and data storage 110. Server computing devices including these components are well known in the art, and means for interconnecting these components are well known in the art. An example server computing device would be an Apple Mac Mini. Other examples include personal computers, notebook computers, blade servers, rack servers, tower servers, and utility computing services. Although the data storage 110 is shown in FIG. 1A within the server computing device, those skilled in the art will realize that the present invention can also be implemented with a server computing device 103 where the data storage 110 is physically external to the remainder of the server computing device. This would be the case, for instance, if the server computing device consisted of the Amazon Elastic Compute Cloud utility computing service connected to the Amazon Simple Storage Service.

Exemplary Software Operating Environment

FIG. 1B shows exemplary software components for one embodiment of the present invention and how they relate to the data computing environment of FIG. 1A.

A Web browser 151 runs on the client computing device 101. Web browsers are well known in the art and examples include Mozilla Firefox, Microsoft Internet Explorer, Apple Safari, Opera Software's Opera browser, and Flock's Flock browser. Server software components 152 run on the server computing device 103. The Web browser 151 communicates with the server software components 152 using Hypertext Transfer Protocol (HTTP) over the network 102. Hypertext Markup Language (HTML) output from the server software components 152 is shown in the Web browser 151. This output can include forms and other widgets that allow the human user to interact with the Web browser. The human user's interactions with the Web browser cause HTTP requests to be sent to the server software components 152.

Exemplary Server Software Components

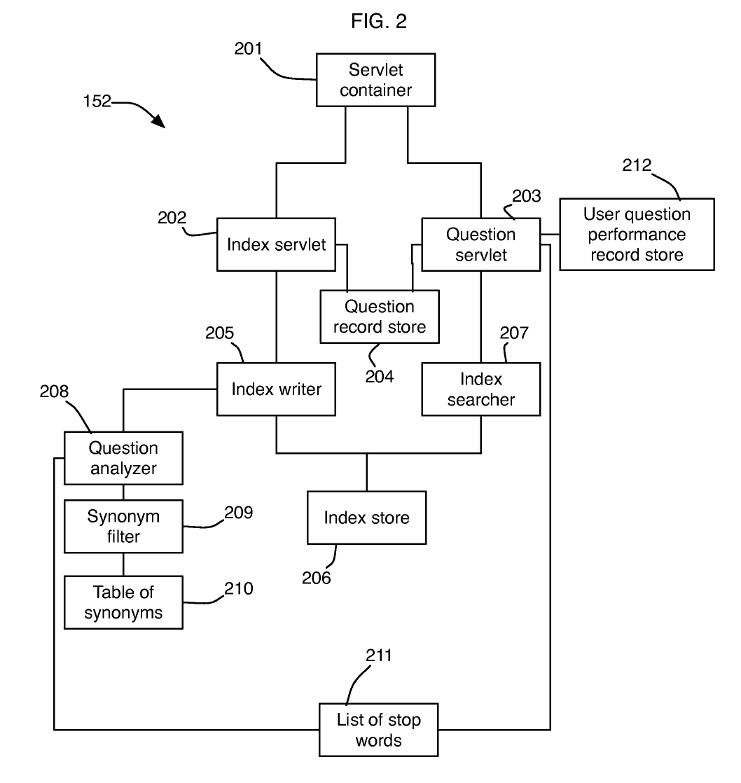

Reference is now made to FIG. 2, wherein there is shown a block diagram of server software components 152 used to implement one embodiment of the invention.

A servlet container 201 contains an index servlet 202 and a question servlet 203. Servlet containers are well known in the art. An example servlet container is Apache Tomcat available from the Apache Software Foundation. Other examples include Jetty from Webtide, and Glassfish from Sun Microsystems. The index servlet 202 and the question servlet 203 are Java classes that extend the javax.servlet.http.servlet class, which is well known in the art and is defined in the Java Platform Enterprise Edition.

The purpose of the index servlet 202 is to process question records into a searchable form. The question servlet 203 governs the interaction of asking questions, providing means for the human user to search for and select answers, and assessing selected answers.

The index servlet 202 and the question servlet 203 read from a question record store 204 that contains question records, which are descriptions of questions and potential answers. In this embodiment, the question record store 204 is a directory of XML files stored on the data storage 110, but those skilled in the art will realize that alternative embodiments can include database records, binary files, formatted text files, and other data recording formats.

The index servlet 202 uses an index writer 205 to write data about question records to an index store 206 that is readable by an index searcher 207. The index searcher 207 is used by the question servlet 203. Index writers and index searchers are well known in the art. In this embodiment, the org.apache.lucene.index.IndexWriter and org.apache.lucene.search.IndexSearcher classes of Apache Lucene are used. Apache Lucene is an open-source search platform available from the Apache Software Foundation. The index writer 205 is configured to use a question analyzer 208 that is a subclass of the org.apache.lucene.analysis.Analyzer class.

The question analyzer 208 uses a synonym filter 209 which is a subclass of org.apache.lucene.analysis.TokenFilter. The synonym filter 209 refers to a table of synonyms 210 that for each word lists words that are considered to be synonyms to that word. Words that are not present in the table of synonyms 210 are considered not to have synonyms. In this embodiment, the table of synonyms 210 is implemented as a relational database table, but alternative embodiments may use hash maps, two dimensional arrays, XML files, binary files, Apache Lucene index stores, or any other means for data storage.

The question analyzer 208 and the question servlet 203 each refer to a list of stop words 211 that lists words that are considered too common to be useful in a search query. In this embodiment, the list of stop words 211 is implemented as a static array of Strings, but those skilled in the art will realise that alternative embodiments may use text files, XML files, binary files, relational database tables, or any other means for data storage.

The question servlet 203 stores user question performance records in a user question performance record store 212. In this embodiment, the user question performance record store 212 is an XML file, but those skilled in the art will realize that alternative embodiments can include formatted text files, binary files, database tables, and other data recording formats.

Record Fields

In this embodiment, question records contain the following fields:
question identifier—as a String. This field identifies the question.
question prompt—as a String. This field is the prompt that is shown to the user—in other words, it is the question.
number of answers required—as an Integer. This field specifies how many answers the human user must select to complete the question. The minimum useful value for this field is one. (A question that requires no answers is not considered useful.)
restrictive search—as a Boolean. This field identifies whether potential answers that are returned in the search should be restricted to those that contain all of the keywords in the search query.
maximum searches—as an Integer. This field, if it is not empty, sets a maximum number of search queries that a human user may enter for this question. Values less than one are not useful. (A question that allows no searches is not considered useful).
search keywords—as a Boolean. This field specifies whether the keywords in the answer records should be indexed.
search answer—as a Boolean. This field specifies whether the answer (the text of the answer) in the answer records should be indexed.
minimum keywords—as an Integer. This field, if it is not empty, specifies a minimum number of keywords that a human user's search query must contain in order to be valid. For example, if the minimum keywords field is 2, then search queries only containing one word are not considered valid.
search adjustment—as a Decimal number. This field allows a human user's mark score for the question to be adjusted depending on the number of search queries that he or she used.
use synonyms—as a Boolean. This field determines whether synonyms to words from the answer record that are being indexed should also be indexed.

Question records also contain a list of answer records, each of which contain the following fields:
answer—as a String
keywords—as a String
score value—as a Decimal number
feedback—as a String

User question performance records contain the following fields:
list of searches so far—as a list of Strings
list of selected answers so far—as a list of Strings
score—as a Decimal number
feedback—as a list of Strings

Detail of the question servlet 203

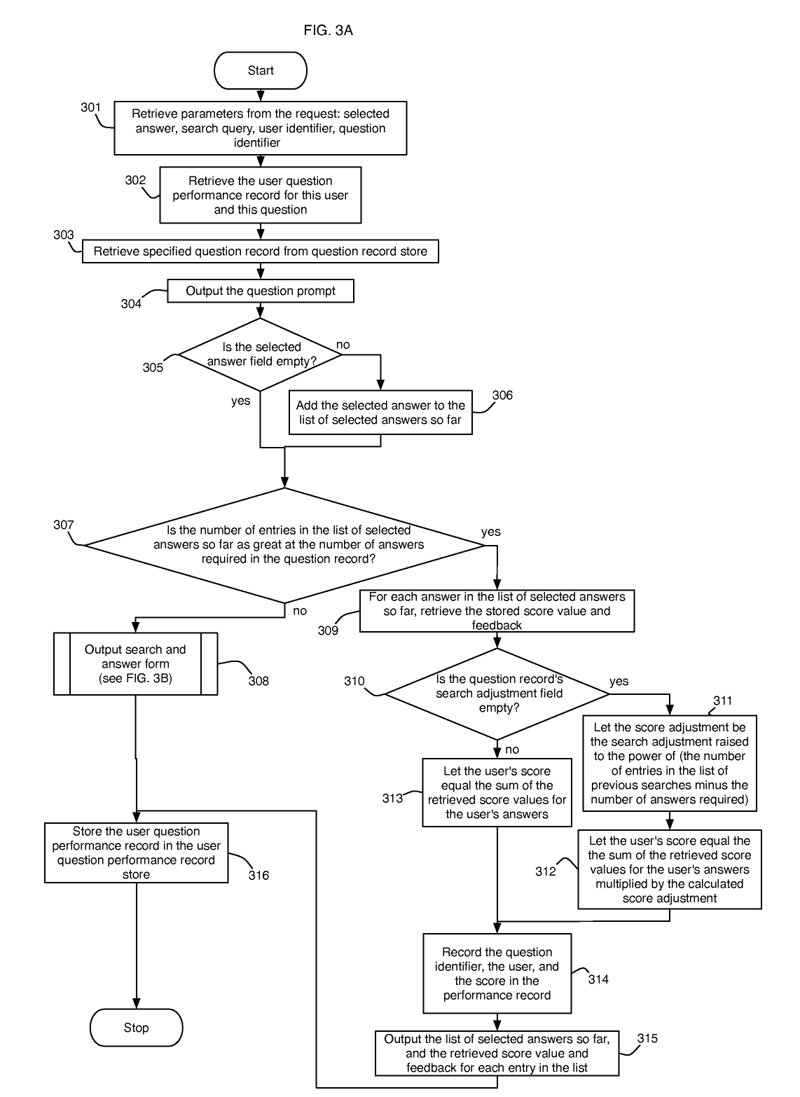

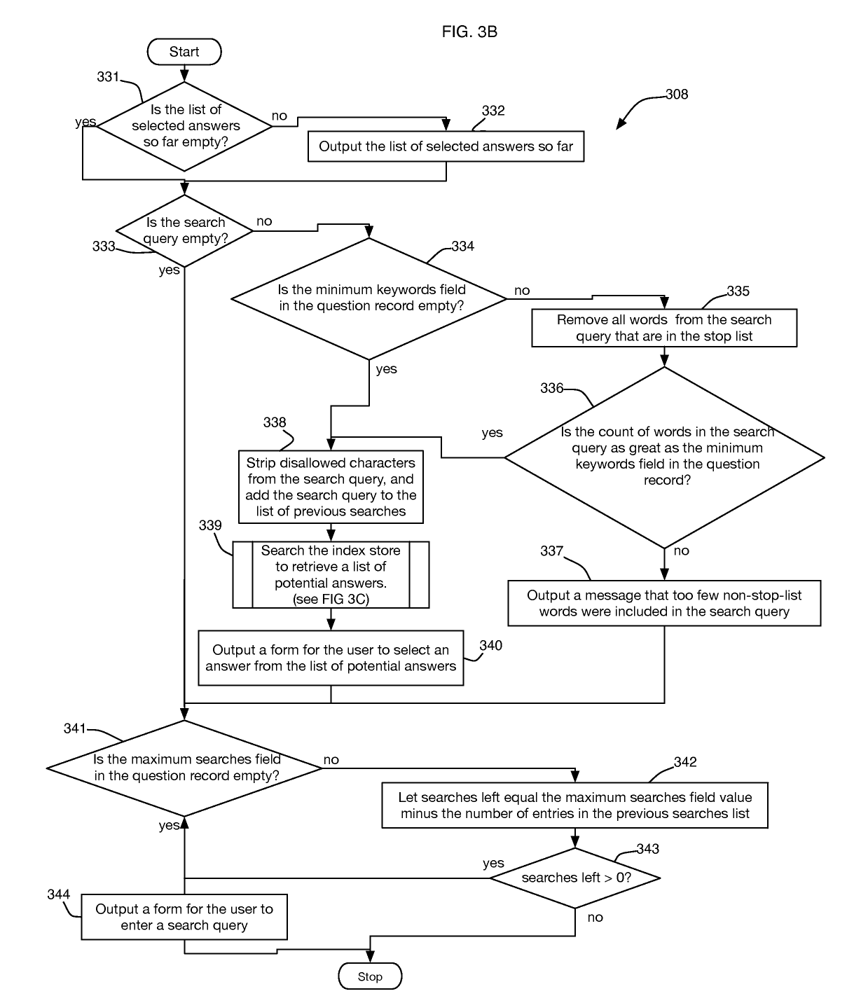

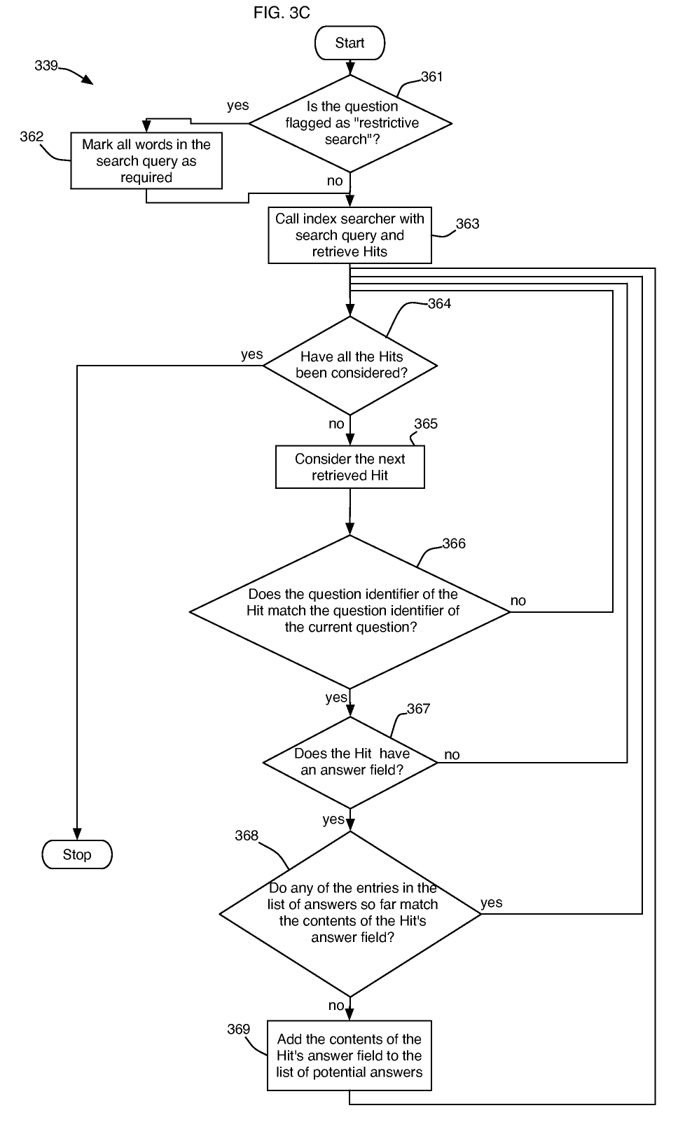

Reference is now made to FIG. 3A, which shows a logic flow diagram illustrating a technique for responding to a human user's input in a question.

The question servlet 203 governs the process of asking a question to the human user and responding to input from that human user. It does this by engaging in the following procedure whenever it receives an HTTP request from the Web browser.

At step 301, retrieve the following parameters from the HTTP request: selected answer, search query, user identifier, and question identifier. If the human user is not selecting an answer in this request, then the selected answer will be empty. If the human user is not submitting a search query in this request, then the search query will be empty. These two situations occur, for example, when the human user first accesses the question.

At step 302, retrieve the user question performance record for the user identified by the user identifier and the question identified by the question identifier. The user question performance record is retrieved from the user question performance record store 212. If there is no user question performance record for this user and this question, then create an empty user question performance record for this user and this question. This situation occurs, for example, when the human user first accesses the question.

At step 303, retrieve the question record for the question identified by the question identifier from the question record store 204.

At step 304, output the question prompt from the question record.

At step 305, consider whether the selected answer retrieved at step 301 is empty. If it is not empty, then at step 306 add the selected answer to the list of selected answers so far in the user question performance record. If it is empty, then flow directly to step 307.

At step 307, consider whether the number of entries in the list of selected answers so far is as great as the number of answers required in the question record. In other words, consider whether the human user has selected as many answers as the question requires. If the human user has not selected as many answers as the question requires, then flow to step 308. Step 308, described in detail later, outputs a search and answer form so that the human user can search for potential answers and select them as answers. If the human user has selected as many answers as the question requires, then flow to step 309. Step 309 begins the process of taking assessment actions on the human user's answers.

At step 309, retrieve the stored score value and feedback from the question record for each answer the human user has selected (each entry in the list of selected answers so far in the user question performance record).

At step 310, consider whether the question record's search adjustment field is empty. If it is not empty, flow to step 311. If it is empty, flow to step 313.

At step 311, calculate a score adjustment. The aim of the score adjustment is to reduce the score available for a question as the human user performs more searches. A human user must make at least one search in order to select an answer, and it is reasonable to expect that many questions cannot be successfully answered without making at least one search per answer required. The score adjustment is calculated in this embodiment as s raised to the power of (n−r), where s is the value of the search adjustment field, n is the number of searches used (the number of entries in the list of searches so far), and r is the number of answers required in the question record. For example, if the question record requires two answers to be selected, the search adjustment field is 0.9, and there are four entries in the list of searches so far, then the score adjustment would be 0.9 to the power of (4−2). Thus, the score adjustment would be 0.81. If there were only two entries in the list of searches so far, the score adjustment would be 0.9 to the power of (2−2), which is 1.

At step 312, the human user's score is calculated as the sum of the score values retrieved at step 309, multiplied by the score adjustment. Step 312 then flows to step 314.

At step 313, which is reached only if the search adjustment field is empty, the human user's score is calculated as the sum of the score values retrieved at step 309.

At step 314, record the question identifier, the user identifier, and the score in the user question performance record. This step records the human user's assessed performance on the question.

At step 315, output the list of selected answers so far and the retrieved score value and feedback for each entry in the list. This step provides the human user with feedback on the answers he or she selected in the process of answering the question.

Step 316 is reached from either step 308 or step 315. At step 316, record the user question performance record in the user question performance record store 212.

Detail Of Step 308

Reference is now made to FIG. 3B, which shows a logic flow diagram illustrating a technique for outputting a search and answer form. This is a detailed view of step 308.

At step 331, consider whether the list of selected answers so far is empty. If it is not empty, then at step 332 output the list of selected answers so far.

At step 333, consider whether the search query is empty. If it is not empty then proceed to step 334. If it is empty, proceed directly to step 341.

At step 334, the search query is not empty. Consider whether the minimum keywords field in the question record is empty. If it is not empty, then proceed to step 335 in order to consider whether the search query contains enough keywords. If it is empty, proceed to step 338 in order to execute the search.

At step 335, remove all words from the search query that are contained in the list of stop words 211. Then, at step 336, compare the number of words remaining in the search query with the value of the minimum keywords field. If the number of words remaining in the search query is at least as great as the value of the minimum keywords field (if there are enough words in the search query) then proceed to step 338 in order to execute the search. Otherwise, at step 337, output a message that too few non-stop-list words were included in the search query and proceed to step 341.

At step 338, which is reached if a search is to be performed, strip disallowed characters from the search query and add the search query to the list of searches so far in the user question performance record. Stripping disallowed characters (in this embodiment, all non-alphanumeric characters except the space character) from the search query prevents the user from using advanced search features such as wildcards in the search query. Then proceed to step 339, to search the index store to retrieve a list of potential answers. Step 339 is described in more detail later.

At step 340, the search has been performed and a list of potential answers has been retrieved. Output a form for the user to select an answer from the list of potential answers.

Step 341 can be reached from steps 333, 337, and 340. At step 341, consider whether the maximum searches field of the question record is empty. If it is not empty, proceed to step 342 to consider whether the human user has any searches left. If it is empty, proceed to step 344.

At step 342, calculate the number of searches left as (m−n), where m is the value of the maximum searches field, and n is the number of searches in the list of searches so far. Then, at step 343, consider whether the number of searches left is greater than zero. If the number of searches left is greater than zero, then proceed to step 344 to output a search form. Otherwise, do not output a search form.

At step 344, output a form for the user to enter and submit a search query.

Detail Of Step 339

Reference is now made to FIG. 3C, which shows a logic flow diagram illustrating a technique for searching an index store to retrieve a list of potential answers. This is a detailed view of step 339.

At step 361 consider whether the value of the question record's restrictive search field is true. If it is true, then at step 362 mark all words (also called terms) in the search query as required. Where the Apache Lucene search components are used, as in this exemplary embodiment, this can be achieved by inserting a plus character (‘+’) before each word in the search query. The Apache Lucene index searcher will only retrieve hits that contain all the words marked as required. As the hits contain information on the potential answers, possibly including synonyms (see later), this ensures that potential answers are only deemed relevant to the search query if they contain or are associated with all the words in the search query.

At step 363, call the index searcher 207 with the search query on the index store 206, and retrieve a list of hits. Hits are well known in the art, and are records returned by an index searcher that are deemed relevant to the search query.

At step 364, consider whether all the retrieved hits have been considered. If they have all been considered, then the process of retrieving a list of potential answers has completed. Otherwise, at step 365, consider the next retrieved hit. (The first time through step 364, the next retrieved hit is the first retrieved hit in the list.)

At step 366, consider whether there is a question identifier field in the hit that matches the question identifier of the current question (the question identifier parameter in the HTTP request). If there is, continue to step 367. Otherwise return to step 364.

At step 367, consider whether the hit contains an answer field. This would indicate that the hit represents a relevant potential answer. If it does contain an answer field, then continue to step 368. Otherwise return to step 364.

At step 368, consider whether the contents of the Hit's answer field match any of the entries in the list of selected answers so far. (In other words, consider whether the human user has already selected this answer.) If it does match any of the entries in the list of selected answers so far, then return to step 364.

At step 369, record the contents of the answer field in a list of potential answers to return. Then return to step 364 to determine whether there are any further hits to consider.

Detail Of The Index Servlet

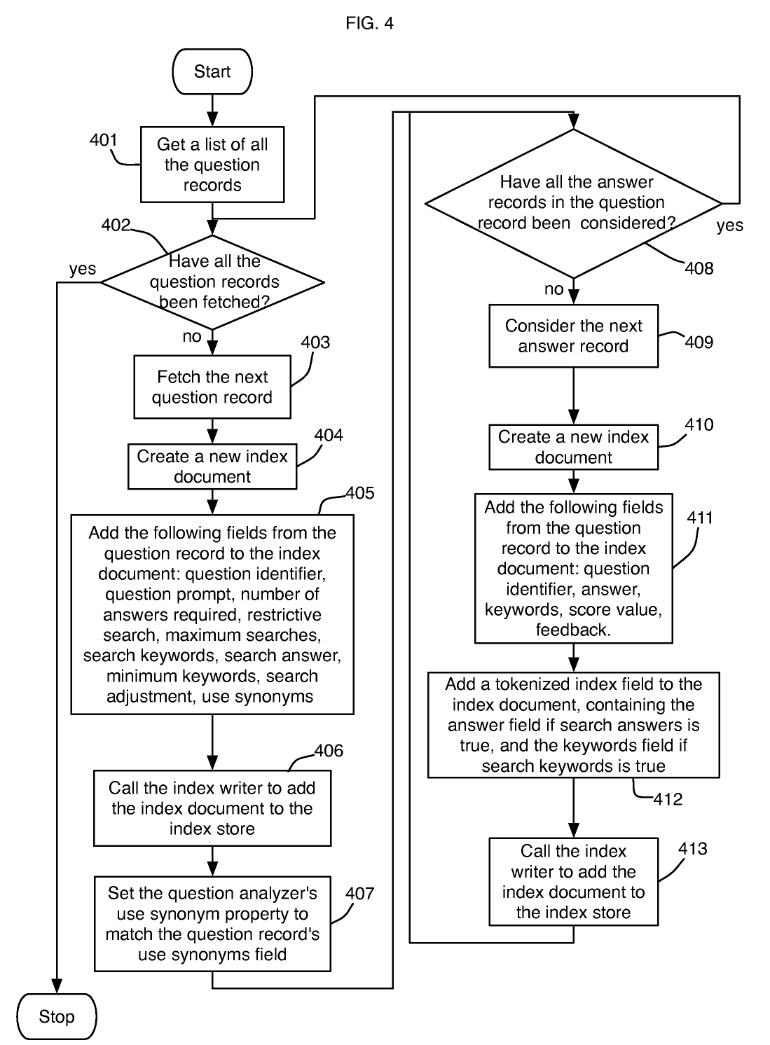

Reference is now made to FIG. 4, which shows a logic flow diagram illustrating a technique for the index servlet 202 to write details about question records to the index store 206.

At step 401, retrieve a list of all the question records in the question record store 204.

At step 402, consider whether all of the question records in the retrieved list have already been fetched. If they have, then the the process of indexing the questions has completed. If they have not, then at step 403 fetch the next question record. (This is the first question record if no question records have yet been fetched.)

At step 404, create an index document for this question record. If the Apache Lucene search platform is used, as in this embodiment, then an index document is an instance of the org.apache.lucene.document.Document class or one of its subclasses. Other search platforms similarly provide their own record-keeping structures.

At step 405, record the fields of the question record into the index document.

At step 406, call the index writer 205 to write the index document to the index store 206.

At step 407, set the use synonyms property of the question analyzer 208 to match the use synonyms field of the question record.

At step 408, consider whether all the answer records in the question record have been considered. If they have, then return to step 402. If they have not, then at step 409 consider the next answer record. (If no answer records have yet been considered, this is the first answer record.)

At step 410, create a new index document and at step 411 record the question identifier from the question record and the fields from the answer record into the index document.

At step 412, write an index field into the index document, marking the field to be tokenized. If the search answer field is true on the question record, then the contents of the answer field is recorded into the index field, with all punctuation replaced by spaces. If the search keywords field is true on the question record, then the contents of the keywords field is recorded into the index field, with all punctuation replaced by spaces. (If both search answer and search keywords is true, then the contents of both the answer and keywords fields is recorded into the index field.)

Those skilled in the art will realise that marking the field to be tokenized using Apache Lucene ensures that it can later be searched using terms that may appear in the field. Replacing the punctuation with spaces ensures that punctuation marks do not interfere in the tokenization process. As the fields that are recorded into this tokenized field depend on the “search keywords” and “search answers” fields, this allows those fields to control whether a search query can be used to match terms in the keywords or the answer fields, or both.

At step 413, call the index writer 205 to write the index document to the index store 206. Then return to step 408.

Detail of the Question Analyzer

The question analyzer 208 is called by the index writer 205, and, as is well known in the art and described in the published documentation for Apache Lucene, represents a policy for extracting index terms from text. The question analyzer 208 is a subclass of the org.apache.lucene.analysis.Analyzer class. The question analyzer 208 has a publicly settable use synonyms property, which controls whether the extracted index terms should include synonyms of words in the text.

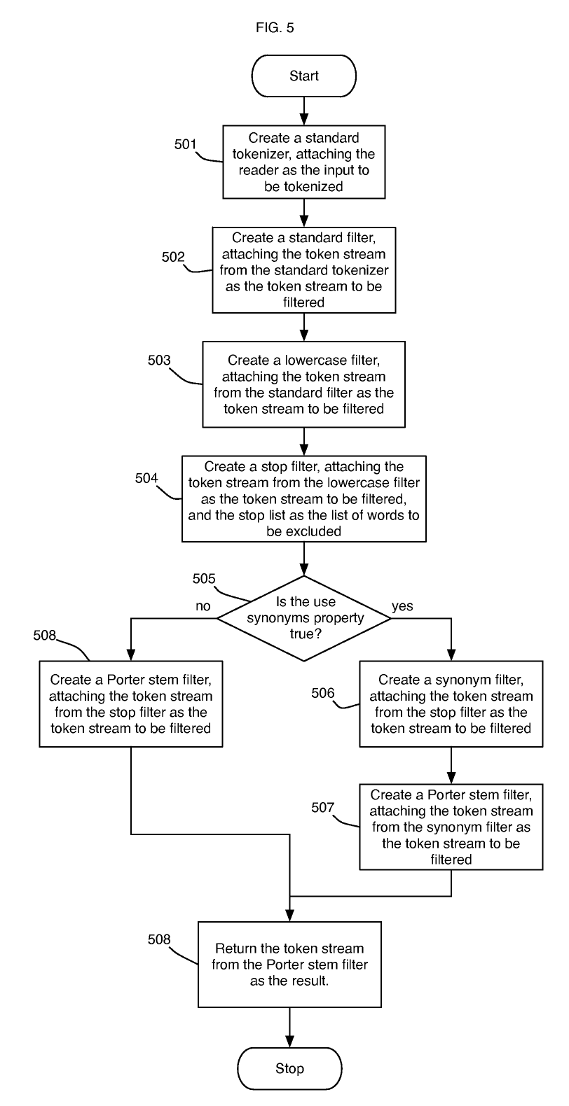

Reference is now made to FIG. 5, which shows a logic flow diagram illustrating a technique for a question analyzer 208 to construct a token stream from a field name and a reader. Token streams are well known in the art, and form part of the Apache Lucene platform: specifically, the org.apache.lucene.analysis.TokenStream class. Readers are well known in the art and form part of the Java Standard Edition platform (and thus also included in the Java Enterprise Edition).

At step 501, a standard tokenizer (an instance of the org.apache.lucene.analysis.standard.StandardTokenizer class) is created, passing the reader as a parameter. A standard tokenizer is considered a token stream.

At step 502, a standard filter (an instance of the org.apache.lucene.analysis.standard.StandardFilter class) is created, passing the standard tokenizer as a parameter. A standard filter is considered a token stream.

At step 503, a lowercase filter (an instance of the org.apache.lucene.analysis.standard.LowerCaseFilter class) is created, passing the standard filter as a parameter. A lowercase filter is considered a token stream.

At step 504, a stop filter (an instance of the org.apache.lucene.analysis.standard.StopFilter class) is created, passing the lowercase filter and the list of stop words 211 as parameters. A stop filter is considered a token stream.

At step 505, consider whether the use synonyms parameter of the question analyzer 208 is true.

If it is true, then at step 506, create a synonym filter 209, and attach the stop filter as the token stream that the synonym filter 209 should filter. The synonym filter is considered a token stream. Then at step 507, create a Porter stem filter (an instance of the org.apache.lucene.analysis.PorterStemFilter class), passing the synonym filter as a parameter. A Porter stem filter is considered a token stream.

If the user synonym property of the question analyzer is false, then at step 508, create a Porter stem filter (an instance of the org.apache.lucene.analysis.PorterStemFilter class), passing the stop filter as a parameter.

Steps 507 and 508 proceed to step 509, where the Porter stem filter (created in either step 507 or step 508) is returned as the resultant token stream.

Detail of the Synonym Filter

A synonym filter 209 filters a token stream and is itself considered a token stream. As the synonym filter 209 is read as a token stream, the result of each call for the next token in the stream should be either a token from the token stream being filtered, or a synonym of a token from that token stream.

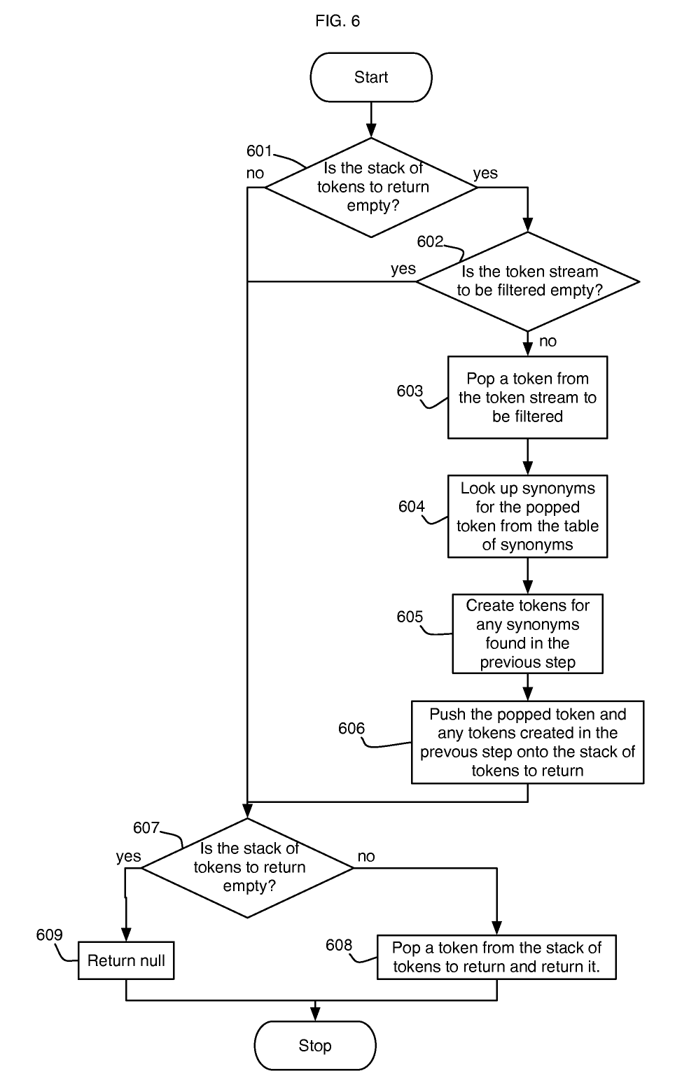

Reference is now made to FIG. 6, which shows a logic flow diagram illustrating a technique for a synonym filter 209 to return the next token that it should return.

The synonym filter 209 maintains a stack of tokens to return. At step 601, consider whether the stack of tokens to return is empty. If it is not empty, then proceed to step 607.

If it is empty, then at step 602, consider whether the token stream to be filtered is empty.

If the token stream to be filtered is empty then proceed to step 607. If it is not empty, then at step 603, pop the next token from the token stream to be filtered.

At step 604, look up synonyms for the popped token from the table of synonyms 210.

At step 605, create tokens for any retrieved synonyms.

at step 606, push the popped token and any tokens created at step 605 onto the stack of tokens to be returned.

At step 607, consider again whether the stack of tokens to return is empty.

If it is not empty, then at step 608, pop a token from the stack of tokens to return and return it.

If it is empty, then at step 609, return null

Operation

Preparation

When the index servlet 202 is accessed, question records from the question record store 204 are indexed into the index store 206.

Within the operation of the index servlet 202, illustrated in FIG. 4, steps 401 to 406 successively retrieve each question record and write their fields into an index document that the index writer 205 writes into the index store 206. Steps 407 to 413 similarly cause the details of each answer record within each question record to be written to the index store 206. Step 412 ensures that depending on the search keywords and search answers fields of the question record, the index field that is tokenized for searching includes the contents of the answer record's keywords field, answer field, or both.

The index writer 205 is configured to use a question analyzer 208, as shown in FIG. 2. Step 407 (shown in FIG. 4) in the operation of the index servlet 202 ensures that when the index writer 205 writes the details of each answer record to the index store 206, the use synonyms property of the question analyzer 208 is set to the same value as the use synonyms field of the question record.

Within the operation of the question analyzer 208, illustrated in FIG. 5, step 501 creates a standard tokenizer that uses the reader it is passed (by the Apache Lucene platform), and that is accessible as a token stream.

Steps 502 to 504 attach filters to the token stream that perform filtering operations that are standard to the Apache Lucene platform, convert tokens to lowercase, and remove tokens that match words in the list of stop words 211. Each successive filter is the token stream that is passed to the next filter.

If the use synonyms property of the question analyzer 208 is true (caused by the use synonyms field of the question record being true), then step 506 attaches a synonym filter 209 to the token stream at this step.

Step 507 or 508 then attaches a filter that applies the Porter stemming algorithm that is well known in the art. This final filter, also being accessible as a token stream, is then returned as the resulting token stream.

Within the operation of the synonym filter 209, illustrated in FIG. 6, a stack of tokens to return maintains the context between calls for the next token. Steps 601 to 606 ensure that whenever the stack of tokens to be returned is empty, the next token is read from the token stream to be filtered and synonyms for this token are looked up from the table of synonyms 210 (and tokens are created for them). These are then pushed onto the stack of tokens to return.

Steps 607 and 608 pop tokens from the stack of tokens to return. Step 609 returns null if the stack of tokens to return is empty and there are no more tokens on the token stream to be filtered.

This algorithm ensures that progressive calls for the next token from the synonym filter returns each token from the token stream to be filtered, followed by tokens for each synonym of that token (from the table of synonyms 210).

First Access Of A Question

Human users access questions through the Web browser 151 making requests to the question servlet 203. (These requests pass via the network 102 and servlet container 201.)

When a human user first accesses a question, the question prompt is output at step 304 of FIG. 3A. There are no selected answers in the list of selected answers so far. So, at step 307, the number of entries in this list (zero) is less than the number of answers. Therefore, step 308 is executed.

Within the detail of step 308 (FIG. 3B), the list of selected answers so far is empty at step 331, so the process flows to step 333. The search query parameter from the request is empty, so the process flows to step 341. If the maximum searches field of the question record is empty, the process flows to step 344. Otherwise, as the number of entries in the previous searches list is zero, the process still flows to step 344, via steps 342 and 343. (If the maximum searches field of the question record has a value, it should not be less than one.)

At step 344, a form is output for the user to enter a search query.

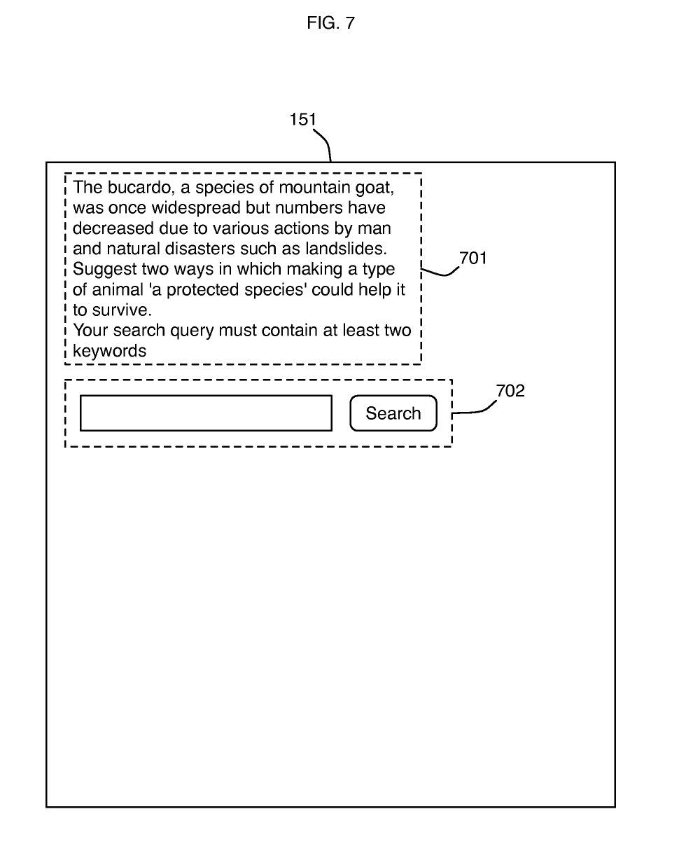

Thus, the output received at the browser in this scenario consists of the question prompt (at step 304) and a form for the user to enter a search query (at step 344). FIG. 7 shows an illustration of exemplary output, indicating the question prompt 701 and the form for the user to enter a search query 702.

Determining When The Answer Is Complete

Consider FIG. 3A again.

Whenever the human user selects a potential answer as his or her answer, step 305 flows to step 306 and the selected answer is added to the list of selected answers so far. Therefore, this list collects each answer the human user selects.

Until the human user has selected as many answers as the question requires (the number of entries in the list of selected answers so far is as great as the number of answers required field in the question record), step 307 always flows to step 308. Furthermore, as soon as the human user has selected as many answers as the question requires, step 307 flows to step 309.

Entering Search Queries

If a human user enters a search query, and has not selected as many answers as the question requires, step 308 is reached. (The question prompt has again been output at step 304 of FIG. 3A.)

Consider FIG. 3B.

The list of selected answers so far collects each answer as the human user selects it, as described earlier. So, if the human user has selected any answers, step 331 flows to step 332, where they are output.

As the search query is not empty, step 333 flows to step 334.

If the minimum keywords field in the question record is not empty, then steps 335 and 336 test whether the search query contains enough words that are not contained in the stop list 211. Words contained in the list of stop words 211 are not deemed significant. So, steps 335 and 336 verify whether the search query contains more than a predetermined number of words that are deemed significant. Only if the search query contains enough non-stop-list words will the search be performed in steps 338 to 340. Otherwise, a message is output at step 337.

If step 338 is reached, then the search query is added to the list of searches so far immediately before the search is executed in step 339. Thus, each search query that is executed for this user and this question is collected in the list of searches so far.

Consider FIG. 3C, which illustrates the details of step 339.

If the question record has the restrictive search field set to true, then steps 361 and 362 ensure that only hits containing all of the words in the search query will be returned.

The search is executed and the hits retrieved in step 363. Steps 364 to 369 then extract from the retrieved hits the answer fields that are for the question identified by the question identifier and that are not already in the list of selected answers so far. So, the result of these steps is a list of potential answers that are deemed relevant to the search query, and that have not been selected as answers by the human user already.

Consider FIG. 3B again.

If a search query is executed at step 339, then a form is output for the user to select any of the returned list of potential answers as an answer. If the list of potential answers returned by step 339 is empty (the search returned no results), then the form for the user to select an answer from the list of potential answers is also empty.

The form for the user to enter a search query is output (at step 344) if and only if step 341 or step 343 flows to step 344. So, the form is only output if the maximum searches field of the question record is empty, or if steps 342 and 343 calculate that the human user still has searches left.

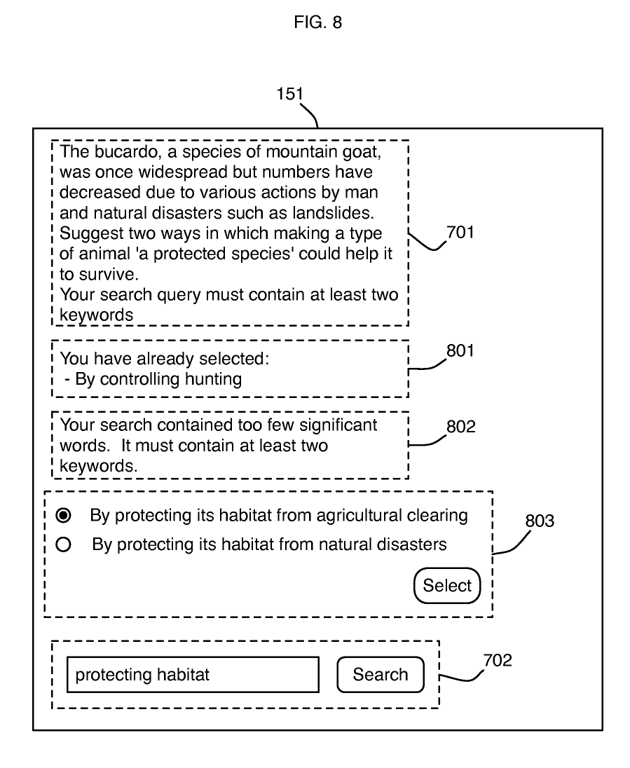

FIG. 8 illustrates the output that the steps described here can produce.

The question prompt 701 is always output.

The list of selected answers so far 801 is output if it is not empty.

The message that the search query contained too few non-stop-list words 802 is output if the search query is not empty, the minimum keywords field in the question record is not empty, and the search query does not contain enough non-stop-list words.

The form for the user to select an answer from the list of potential answers 803 is output if the search query is not empty, either the question record does not require a minimum number of keywords or the search query contains enough non-stop-list words. The form contains the potential answers that are deemed relevant to the search query and have not already been selected as answers by the human user.

The form for the user to enter a search query 702 is output if the maximum searches field of the question record is empty, or step 343 in FIG. 3B determines that the human user has searches left for this question.

Undertaking Assessment Actions

As described earlier, as soon as the human user has selected as many answers as the question requires, step 307 in FIG. 3A flows to step 309.

If the question record's search adjustment field is not empty, then steps 311 and 312 consider both the selected answers and the entered search queries. Particularly, they calculate a sum score for the selected answers and reduce that score depending on the number of entered search queries.

Steps 309 to 314 take an assessment action of determining and recording a score for the user's selected answers. Score values are associated with each predetermined potential answer by the score value field in the answer record within the question record in the question record store 204.

Steps 309 to 315 take an assessment action of providing feedback on each of the user's selected answers. Unique feedback is associated with each predetermined potential answer by the feedback field in the answer record within the question record in the question record store 204.

Alternative Embodiments

While my above description contains many specificities, these should not be construed as limitations of the scope, but rather as an exemplification of one embodiment thereof. Many other variations are possible. For example, a number of variations are described in the following paragraphs. Accordingly, the scope should be determined not by the embodiment illustrated, but by the claims and their legal equivalents.

Alternative Data Computing Environments

Reference is now made to FIG. 1A.

Although the exemplary embodiment is generally described in the context of a client computing device connected to a server computing device via a network, those skilled in the art will realize that the invention can also be implemented in a computing environment where there is a direct connection between the client computing device and the server computing device, for example over a serial link, or where the client computing device and the server computing device are the same physical device. Furthermore, those skilled in the art will realize that the invention can be implemented in a computing environment where the client computing device and the server computing device are the same physical device, with or without the network 102 being present.

Reference is now made to FIG. 1B.

Although the exemplary embodiment is generally described in the context of a Web browser communicating with server software components over HTTP, those skilled in the art will realize that the invention can also be implemented using alternative communication protocols, for example User Datagram Protocol (UDP), or in the case where the client computing device and the server computing device are the same physical device, function calls or inter-process communication may be used.

Those skilled in the art will also realize that the Web browser may be replaced by an alternative display and input program, for example a custom client using Java Swing, Windows Forms, Adobe AIR, console output and input, or any other technology for human-computer interaction.

Although the exemplary embodiment is generally described in terms of server software components written in the Java language and using the Java Platform Enterprise Edition, those skilled in the art will realize that the server software components may be implemented in other language or using other platforms. These include using alternative web frameworks, for example PHP, Ruby on Rails, Microsoft .NET, or the Apache Web-server attached to modules written in Python, Perl, or any other language.

Those skilled in the art will also realise that if the client computing device is the same physical device as the server computing device, then the alternative display and input program (replacing the Web browser) and the server software components may be implemented as a single program.

Alternative Searching Implementations

Those skilled in the art will realize that the invention may be implemented using a system that writes a different combination of details about each question to the index store. For example, an alternative embodiment may create index documents only for the answer records and not for question record data such as the question prompt and use synonyms fields.

Those skilled in the art will realize that the invention may be implemented with different sets of filters. For example, without a stop list or stop filter, without a table of synonyms or synonym filter, with a different stemming filter, or with other additional filters, or with no filters at all.

Those skilled in the art will realize that the invention may be implemented using different combinations of fields written to the index store. For example, rather than writing a single tokenized index field as an additional field for each answer record, an alternative embodiment may tokenize one or more of the answer records' fields.

Although the exemplary embodiment is generally described using the Apache Lucene indexing and search platform, those skilled in the art will realize that the invention may be implemented using other indexing and search platforms. These include open source search engines, for example Egothor, commercial search components, Web-based search services, and custom-written search methods or components.

Furthermore, those skilled in the art will also realize that the invention may be implemented by a program that does not use an index store, but that examines each answer record for a question directly whenever a search query for that question is received, in order to determine which potential answers are relevant to the search query.

Those skilled in the art will realize that the invention may be implemented using alternative techniques to limit the searches that the user may enter. For example, an alternative embodiment may permit users to re-select previously entered search queries when they have reached the limit of the number of search queries they may enter. An alternative embodiment may limit the number of unique search queries a user may enter, rather than the total number of search queries they enter, thus allowing the user to return to previous search queries without cost.

Those skilled in the art will realize that the invention may be implemented using different techniques to adjust or limit a user's search query. For example, an alternative embodiment may permit wildcards or non-alphanumeric characters, or may use a custom syntax parser to interpret the search query that is entered and then programmatically generate a search query to execute. This may, for instance, ensure that a ‘*’ character entered by a user is used as a mathematical multiplication term in a search query, rather than as a searching wildcard. Also for example, an alternative embodiment may forbid particular words from being included in a search query.

Alternative Assessment Action Implementations

Those skilled in the art will realize that the invention may be implemented using alternative algorithms for adjusting the resulting mark or score depending on the searches that have been entered. For example, a fixed penalty may be subtracted per search (rather than a proportional reduction being applied). An alternative embodiment may consider the number of relevant or irrelevant terms in the search query, or the score that is assigned to each potential answer that was deemed relevant (not just those that are selected as answers). An alternative embodiment may count only the unique search queries a user entered, rather than the total number of search queries, thus not penalizing the user for entering duplicate search queries.

Those skilled in the art will realize that the invention may be implemented using alternative assessment actions. For example, an alternative embodiment may record only feedback and no score, or only a score and no feedback for each answer record. Also for example, an alternative embodiment may store potential answers that are pre-formatted to be syntactically acceptable to a processing engine, and may pass selected answers to that processing engine for assessment.

### Conclusion

Thus the reader will see that with at least one embodiment of the invention, because a user selects, rather than constructs, answers, the user's answers can be marked accurately and unambiguously without complex processing. But because the user must enter a relevant search query for potential answers to be displayed, it is harder for the user to answer the question by guessing alone. Furthermore, the reader will see that at least one embodiment of the invention is useful for a wide variety of questions, and can be used for questions where the expected answer is in natural language (for example, English). Moreover, because the user selects answers, thus confirming that they are the answers that he or she intends, the accuracy of the marking is not dependent on the quality of Natural Language Processing that is available.

### TERMINOLOGY IN CLAIMS

A search query is any text, drawings, or data entered by a human user that is processed in order to produce a set of potential answers to present to the human user.

A potential answer is any text, drawings or data that is presented to the human user that the human user may select as his or her answer to the question.

An assessment action is an action selected from the group consisting of assessing the correctness of an answer, determining a score value for an answer, and identifying appropriate feedback for an answer.

I claim:

1. A method for computer-based assessment including:
a. displaying a question prompt to a human user,
b. providing means for the human user to enter at least one search query,
c. identifying potential answers that are deemed relevant to an entered search query from a set of predetermined potential answers,
d. displaying the identified potential answers to said human user,
e. providing means for the human user to select at least one identified potential answer as an answer,
f. undertaking at least one assessment action on the at least one selected answer,
whereby at least one predetermined potential answer is not displayed to the human user until a relevant search query has been entered, predetermined potential answers are displayed to the human user in response to a relevant search query being entered, the user may select at least one predetermined potential answer as an answer, and at least one assessment action is undertaken on the selected answer or answers.

2. The method of claim 1, wherein the full content of more than one relevant predetermined answer is displayed to the human user in a single response to a single action by the human user, said single action by the human user consisting of entering a search query.

3. The method of claim 1, wherein the search query comprises text

4. The method of claim 1, further including providing means to automatically limit or alter an entered search query.

5. The method of claim 1, further including providing means to limit the number of search queries the human user may enter.

6. The method of claim 1, wherein said at least one assessment action considers both the at least one selected answer and the at least one entered search query.

7. The method of claim 1, wherein a plurality of predetermined potential answers are deemed correct.

8. The method of claim 1, further including providing means to associate a score value with each predetermined potential answer.

9. The method of claim 1, further including providing means to associate unique feedback with each predetermined potential answer.

10. The method of claim 1, further including:
a. providing means to determine whether a word in a search query is deemed significant,
b. providing means to verify that an entered search query contains more than a predetermined number of words that are deemed significant.

11. The method of claim 1, further including providing means to determine whether a word in a search query is deemed significant, and wherein said predetermined potential answers are deemed relevant to a search query only if they contain or are associated with all the words in said search query that are deemed significant.

12. A system for computer-based assessment including:
a. means to display a question prompt to a human user,
b. means for the human user to enter at least one search query,
c. means to identify potential answers that are deemed relevant to a search query from a set of predetermined potential answers,
d. means to display the identified potential answers to the human user,
e. means for the human user to select at least one identified potential answer as an answer,
f. means to undertake at least one assessment action on the selected answer or answers.

13. The system of claim 12, wherein the search query consists of text

14. The system of claim 12, further including means to limit the number of search queries the human user may enter.

15. The system of claim 12, wherein said at least one assessment action considers both the at least one selected answer the at least one entered search query.

16. The system of claim 12, wherein a plurality of predetermined potential answers may be deemed correct.

17. The system of claim 12, further including means to associate a score value with each predetermined potential answer.

18. The system of claim 12, further including:
a. means to determine whether a word in a search query is deemed significant,
b. means to verify that an entered search query contains more than a predetermined number of words that are deemed significant.

19. The system of claim 12, further including means to determine whether a word in a search query is deemed significant, and wherein predetermined potential answers are deemed relevant to a search query only if they contain or are associated with all the words in said search query that are deemed significant.

20. The system of claim 12, further including means to associate unique feedback with each predetermined potential answer.
